(19) United States
(12) Patent Application Publication
(10) Pub. No.: US 2022/0030670 A1
(43) Pub. Date: Jan. 27, 2022

(54) ROBUST PRINTED HEATER CONNECTIONS FOR AUTOMOTIVE APPLICATIONS

(71) Applicant: IEE INTERNATIONAL ELECTRONICS & ENGINEERING S.A., ECHTERNACH (LU)

(72) Inventors: Driss CHABACH, Noertrange (LU); Matthias MASSING, Konz (DE)

(21) Appl. No.: 17/276,295

(22) PCT Filed: Sep. 17, 2019
(86) PCT No.: PCT/EP2019/074780

§ 371 Date: Mar. 15, 2021

(30) Foreign Application Priority Data
Sep. 17, 2018 (LU) LU100929

(51) Int. Cl. H05B 3/34; H05B 3/06

(52) U.S. Cl. CPC H05B 3/34; H05B 3/06; B60H 1/2227; H05B 2203/013; H05B 2203/016

(57) ABSTRACT

An electric heating device, in particular for automotive application, includes a dielectric, planar, flexible carrier, at least one electrically resistive conductor line fixedly attached onto a surface of the flexible carrier and, at least for each end of the conductor line, an electrically conductive terminal line. The terminal lines abut and are electrically connected to a respective end of the conductor line, wherein the terminal lines have a width (w_{T}) that is narrower than a width (w_{R}) of the conductor line. At least one electrically conductive shunt member is attached to at least one out of at least a portion of at least one of the terminal lines and a portion of the at least one conductor line for at least partially electrically shunting the respective portion.

### TECHNICAL FIELD

The invention relates to an electric heating device, in particular for automotive application, comprising at least one electric heater member with a dielectric, planar, flexible carrier.

### BACKGROUND

Electric heating devices are widely used in the automotive industry, for instance for providing passenger comfort by heating a vehicle compartment in general, and/or passenger seats, and/or arm rests, and/or panels, or as a part of a battery temperature management system. Electric heating devices having flexible and/or stretchable heater members are known to be employed in vehicle steering wheels for heating right after start-up of a vehicle engine at cold ambient conditions.

It is considered as one requirement for such electric heating devices that they should be unnoticeable to the vehicle user if not put into operation. Other requirements may be an as even as possible heat density during operation in order to avoid hot spots that may become noticeable to the vehicle user, and also to avoid material fatigue by the occurrence of thermal stress. An ongoing requirement for such applications is that of miniaturization.

The combined requirements generally rule out the use of conventional heating wires such as wires made from copper or from copper-nickel(-manganese) alloys, whose resistivity temperature dependence is very low.

Striving to meet the requirement above, solutions have been proposed in the prior art that employ foil heater members, i.e. heater members having the appearance of a thin flexible foil or film.

For instance, WO 2015/024909 A1 describes a foil heater for a heating panel. The foil heater comprises a first and a second spiral resistive heating trace formed in a first and a second layer, respectively, that conforms to a flat or curved surface. Each of the first and second resistive heating traces has a center and at least one outer extremity. An electrically insulating layer comprising a flexible substrate is arranged between the first and second layer. The heating traces may be produced by printing techniques such as (rotary) screen printing and inkjet printing, using electrically conductive inks based on, for instance, silver and/or copper. The electrically insulating layer comprises an opening that accommodates an electrical via, through which the first and second resistive heating traces are electrically contacted with each other. The foil heater is compatible with operation at lower temperature. Due to their spiral shape, the heating traces can be routed densely over the entire heating surface substantially without crossings. A significantly more uniform temperature distribution can thus be achieved.

A solution particularly for steering wheel heating is described by WO 2016/096815 A1, in which a planar flexible carrier is proposed for use in steering wheel heating and/or sensing. The planar carrier, which can be employed for mounting on a rim of a steering wheel without wrinkles, comprises a portion of planar flexible foil of roughly rectangular shape having two longitudinal sides and two lateral sides. A length B of the lateral sides is 0.96 to 1.00 times the perimeter of the rim. A number of N cut-outs per unit length are provided on each of the longitudinal sides, wherein the cut-outs of one side are located in a staggered fashion relative to opposing cut-out portions on the opposite side.

In one embodiment proposed in WO 2016/096815 A1, a planar, flexible carrier which covers a maximum of the rim surface area supports a parallel electrical heating circuit and so constitutes a heating member. Two of these heating members are attached on the steering wheel rim so that their contacted sides abut to each other and contacts of the same electrical potential are also abutting. The planar, flexible carrier consists of thermo-stabilized, 75 μm polyester foil. The foil serves as a substrate for the polymer thick film (PTF) electrical heating circuit which is applied in three printing passes by flat bed or rotary screen printing. The parallel electrical circuit is applied using a highly conductive PTF silver for the feedlines and for heating, and a low conductive PTF carbon black exhibiting positive temperature coefficient of resistivity (PTCR) characteristics for heating. A print thickness is typically between 5 and 15 μm.

An electrically material conductive layer of uniform thickness t and width w along a length of extension l shows an electric resistance R that can be obtained from a sheet resistance R_{S} and its geometric dimensions by

$$R = {R}_{S} \cdot \frac{l}{w} , {R}_{S} \text{:=} \frac{ρ}{t} \qquad ( 1 )$$

wherein ρ denotes the specific electric resistivity of the electrically conductive material layer.

For a heater member that includes one such electrically material conductive layer of uniform thickness t forming a conductor path of width w_{R} as a heater member and two conductor paths of width w_{T} as electric connecting terminals at its ends, a same supplied current I will be flowing through the heater member and the connecting terminals. A dissipated power per unit length equals

$$\frac{P}{l} = {I}^{2} \cdot \frac{ρ}{t \cdot {w}_{R , T}} = {I}^{2} \cdot R \cdot \frac{1}{{w}_{R , T}} \qquad ( 2 )$$

and thus scales with the inverse of the layer width w_{R} and w_{T}, respectively.

For an increasing ratio

$$\frac{{w}_{R}}{{w}_{T}} ,$$

more and more of the electric power intended for producing heat in the printed conductor path of the heater member undesirably becomes dissipated within a region of the electric connecting terminals instead, which may result in an occurrence of hot spots and eventually a malfunction of a heater member connected to the terminal lines.

The omnipresent space limitations push designers towards narrower electric terminal lines and conductor lines. As can be obtained from formula (2), a decrease of the width w can be compensated by a same decrease of the sheet resistance R_{S}, i.e. by decreasing the specific electric resistivity ρ or by increasing the uniform thickness t.

The most conductive silver inks that are available in the market have a specific electric resistivity ρ between 0.75·10⁻⁷ Ω·m and 1.0·10⁻⁷ Ω·m. For a uniform thickness t of 25 μm, this results in a sheet resistance R_{S} between 3.0 and 4.0 mΩ/square. Such low sheet resistance R_{S} is achievable only with inks having a high silver load. This has a large impact on cost efficiency and further results in a significant decrease of the mechanical robustness in terms of resistance to bending of the printed conductor path, as highly conductive silver inks are known to be mechanically fragile.

An increase of the uniform thickness t is no viable solution, as printing such inks in a thickness t of more than 15 μm drastically increases their fragility. Therefore, a solution is needed to reduce the risk of a potential heat stress in a region of the electric terminal lines while the heater member is being put into operation.

### SUMMARY

It is therefore an object of the invention to provide an electric heating device, in particular for automotive applications, having one or more heater members formed as conductive paths on a flexible carrier, which is as unnoticeable to a user as possible if not put into operation, which requires as little space for connecting to an electric power source as possible and by which an occurrence of hot spots during operation can effectively be avoided.

In one aspect of the present invention, the object is achieved by an electric heating device, which comprises at least one electric heater member. The at least one electric heater member includes a dielectric, planar, flexible carrier and at least one electrically resistive conductor line of uniform thickness that is fixedly attached onto a surface of the flexible carrier. The at least one electric heater member further comprises, at least for one end of the at least one electrically resistive conductor line, an electrically conductive terminal line that is attached onto the surface of the flexible carrier, and is abutting and is electrically connected to the respective end of the at least one electrically resistive conductor line. Moreover, the electrically conductive terminal lines have a width that is narrower than a width of the at least one electrically resistive conductor line.

Furthermore, the electric heating device includes at least one electrically conductive shunt member that is attached to at least one out of at least a portion of at least one of the electrically conductive terminal lines and a portion of the at least one electrically resistive conductor line for at least partially electrically shunting the respective portion.

The embodiments of the invention described herein take advantage of the discovery that an electrically conductive shunt member can be employed for providing an electrically conductive terminal line with reduced electric resistance without increasing a width of the terminal line.

As the same electric current flows through the at least one electrically resistive conductor line as through the combination of the electrically conductive terminal line and the shunt member, when the electric heating device is put into operation, less electric power is dissipated in the shunted terminal line. A heat flux density, i.e. a heat energy per unit area per time, is locally reduced in the region of the terminal line. In this way, an occurrence of hotspots during operation of the electric heating device that may become noticeable to a user, for instance a vehicle user, can effectively be avoided. Moreover, material fatigue by the occurrence of thermal stress in the terminal line can be prevented.

The invention is, without being limited to, in particular beneficially employable in automotive applications, but may as well be used in other technical fields in which a space constraint exists with regard to electric heater member terminal lines. The term “automotive”, as used in this patent application, shall particularly be understood as being suitable for use in vehicles including passenger cars, trucks, semi-trailer trucks and buses.

The term “flexible carrier”, as used in this application, shall in particular be understood such that the carrier can be deformed elastically by applying human power without use of any tool, and that the carrier returns to its original shape when the applied human power is removed.

Preferably, the flexible carrier is formed as a flexible carrier foil. Also preferably, a major portion of the at least one electrically resistive conductor line consists of at least one metal such as Cu, Ag, Au, or Al. Alternatively, a major portion of the at least one electrically resistive conductor line may consist of a composite formed of metal flakes (suitable metals are, e.g., Cu, Ag, Au, Al, and so forth) and at least one polymer binder.

The phrase “a major part”, as used in this application, shall particularly be understood as a volumetric portion of at least 50%, more preferable of more than 70%, and, most preferable, of more than 80% of the at least one electrically resistive conductor line. A volumetric portion of 100% shall as well be encompassed.

In preferred embodiments, the electric heating device includes an electrically conductive adhesive layer that is arranged between the portion of the terminal line or the portion of the at least one electrically resistive conductor line and the at least one electrically conductive shunt member for providing an appropriate attachment as an electrically conductive adhesive bond. In this way, a uniform attachment can be accomplished between the at least one electrically conductive shunt member and the portion of the terminal line or the portion of the at least one electrically resistive conductor line, with resulting positive electric properties regarding the shunting.

Preferably, for providing an appropriate attachment for the at least one electrically conductive shunt member, the electric heating device includes a plastic film and an adhesive layer that are arranged on top of the at least one electrically conductive shunt member, and the plastic film is adhesively attached by the adhesive layer to the flexible carrier at opposite sides of the portion of the terminal line or at opposite sides of the portion of the at least one electrically resistive conductor line. In this way, a simple and reliable way of indirectly and reliably attaching the at least one electrically conductive shunt member to at least the portion of the terminal line or to the portion of the at least one electrically resistive conductor line can be achieved.

In some preferred embodiments, the plastic film and the adhesive layer material may be separate entities before an assembly of the electric heating device. In other preferred embodiments, the plastic film may be formed as a self-adhesive plastic film, wherein the plastic film is furnished with an adhesive layer prior to an assembly of the electric heating device.

Preferably, the adhesive layer comprises a pressure-sensitive adhesive (PSA). By that, a laminate structure can be formed without applying any thermal stress to components of the electric heating device. Pressure-sensitive adhesives are commonly commercially available and may for instance be based on acrylates.

In preferred embodiments, the at least one electrically conductive shunt member is attached to at least the portion of the terminal line or the portion of the at least one electrically resistive conductor line by means for establishing at least one material bond joint. By the at least one material bond joint, a very reliable attachment can be achieved with a relatively small effort.

Preferably, the means for establishing at least one material bond joint comprise metallic means and the at least one material bond joint is established by a soldering process.

In preferred embodiments of the electric heating device, the at least one electrically conductive shunt member is attached to at least the portion of the terminal line or to the portion of the at least one electrically resistive conductor line by means for establishing at least one force fit joint, form fit joint or combined force/form fit joint. By establishing the at least one force fit joint between the at least one electrically conductive shunt member and at least the portion of the terminal line or the portion of the at least one electrically resistive conductor line, a very reliable attachment can be provided in a fast manner.

Preferably, the at least one force fit joint, form fit joint or combined force/form fit joint is established as a riveted joint, a crimped joint or as a clinched joint.

In preferred embodiments of the electric heating device, the at least one electrically conductive shunt member is formed as at least one out of a strip of an electrically conductive textile, a strip of copper film and a strip of plastic foil with an attached electrically conductive layer comprising cured electrically highly conductive ink. In this way, appropriate electrically conductive shunt members can readily be provided. The electrically conductive layer may be attached onto a surface of the strip of plastic foil to cover a minor part, a major part or all of the surface of the strip of plastic foil.

For the purposes of the present invention, the term “textile” shall particularly be understood to encompass any flexible material consisting of a network of natural or synthetic fibers, e.g. yarns or threads. Yarn may be produced by spinning raw natural fibers such as wool, flax, cotton, hemp, or other materials such as synthetic fibers, to produce long strands. Textiles may be produced by weaving, knitting, crocheting, knotting, felting, or braiding. Woven textiles are to be understood in particular as a surface fabric comprising at least two interlaced thread systems arranged essentially perpendicular to one another (for instance warp and weft). In this context, a knitted textile or knitted fabric is to be understood in particular to mean a textile produced by interlooping of yarns. The term “textile” shall also include non-woven fabrics made from intermingled or bonded-together fibers and shall encompass felt, which is neither woven nor knitted.

The phrase “electrically conductive textile”, as used in this application, shall in particular encompass textiles having a continuous layer of electrically conductive material attached to and covering at least a major part of at least one surface, which is to be arranged to face the portion of the terminal line or the portion of the at least one electrically resistive conductor line. The continuous layer of electrically conductive material may be attached to the at least one surface by applying a physical vapor deposition (PVD) method such as evaporation or sputtering, or may be attached galvanically by electroplating.

Preferably, the electrically conductive layer comprising cured electrically highly conductive ink may be attached to the strip of plastic foil by (rotary) screen printing or inkjet printing, using electrically highly conductive inks based on, for instance, silver and/or copper.

In embodiments of electric heating devices, in which the at least one electrically conductive shunt member is formed as a strip of an electrically conductive textile having a textile carrier and a continuous electrically conductive layer attached to a surface of the textile carrier and extending over a major part of an area of the surface, the continuous electrically conductive layer preferably comprises at least one material out of a group formed by copper, nickel, silver, manganese and a combination of at least two of these. By that, a wide range of electric sheet resistances can readily be provided. In suitable embodiments, a high degree of corrosion resistance in the presence of high humidity and a large stretching ability without breakage can further be achieved.

Preferably, the portion of the terminal line or the portion of the at least one electrically resistive conductor line completely overlaps the at least one electrically conductive shunt member in a direction perpendicular to the surface of the flexible carrier. In this way, an electrically conductive terminal line with reduced electric resistance for connecting to an electric power source can be provided without increasing a required space for installation in a direction that is aligned parallel to a surface of the flexible carrier and perpendicular to the electrically conductive terminal line.

In preferred embodiments of the electric heating device, a sheet resistance of the at least one electrically conductive shunt member is lower than a sheet resistance of the portion of the terminal line or of the portion of the at least one electrically resistive conductor line. In this way, a particularly large reduction of the resistance of at least the portion of the terminal line or the portion of the at least one electrically resistive conductor line can be achieved.

In preferred embodiments of the electric heating device, the flexible carrier is a foil that is substantially made from a plastic material selected from, but not limited to, a group of plastic materials formed by polyethylene terephthalate (PET), polyimide (PI), polyetherimide (PEI), polyethylene naphthalate (PEN), polyoxymethylene (POM), polamide (PA), polyphthalamide (PPA), polyether ether ketone (PEEK), and combinations of at least two of these plastic materials. These plastic materials are cost-effective and commercially available, and can allow for easy manufacturing. Durable carriers of low manufacturing tolerances can readily be provided in this way.

Preferably, the at least one electrically resistive conductor line comprises a cured electrically resistive ink. In this way, fast and high-precision mass production processes such as (rotary) screen printing and inkjet printing can be applied for fixedly attaching the at least one electrically resistive conductor line onto the surface of the flexible carrier, which can result in low tolerance margins and high reproducibility and, by that, in an even heat flux density distribution along the at least one electrically resistive conductor line, when the electric heating device is put into operation.

Electrically resistive inks, for instance with positive temperature coefficient, are readily commercially available.

These and other aspects of the invention will be apparent from and elucidated with reference to the embodiments described hereinafter.

It shall be pointed out that the features and measures detailed individually in the preceding description can be combined with one another in any technically meaningful manner and show further embodiments of the invention. The description characterizes and specifies some embodiments of the invention in particular in connection with the figures.

### BRIEF DESCRIPTION OF THE DRAWINGS

Further details and advantages of the present invention will be apparent from the following detailed description of not limiting embodiments with reference to the attached drawing, wherein:

FIG. 1 schematically illustrates a possible embodiment of an electric heating device in accordance with the invention in a perspective exploded view,

FIG. 2 schematically illustrates an alternative embodiment of an electric heating device in accordance with the invention in a plan view, and

FIG. 3 schematically illustrates another alternative embodiment of an electric heating device in accordance with the invention in a perspective view.

### DESCRIPTION OF PREFERRED EMBODIMENTS

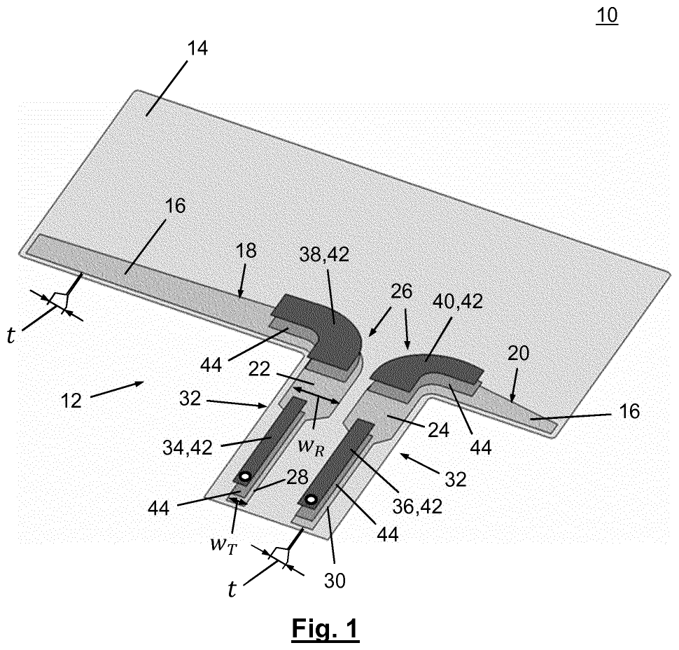

FIG. 1 schematically illustrates a possible embodiment of an electric heating device 10 in accordance with the invention in a perspective exploded view. The electric heating device 10 is intended and configured to be used for heating on demand a vehicle seat arm rest (not shown) of a passenger car.

The electric heating device comprises an electric heater member 12. The electric heater member 12 includes a dielectric, planar, flexible carrier 14, which in this specific embodiment is formed as a plastic foil that has a thickness of 50 μm and that is completely made from polyetherimide (PEI).

The electric heater member 12 further comprises an electrically resistive conductor line 16. The electrically resistive conductor line 16 is fixedly attached onto a surface of the flexible carrier 14, for instance by applying a screen printing process for disposing an electrically resistive ink in the shape of the electrically resistive conductor line 16 and curing the electrically resistive ink. The electrically resistive ink comprises a major part of copper and nickel, so that the electrically resistive conductor line 16 comprises cured electrically resistive ink.

In this specific embodiment, the electrically resistive conductor line 16 in a cured state has a uniform thickness t of about 10 μm, and typically is between 5 μm and 15 μm. FIG. 1 shows line end portions 18, 20 of the electrically resistive conductor line 16, which are electrically connected to a middle portion (not shown) of the electrically resistive conductor line 16. The middle portion of the electrically resistive conductor line 16 is formed as a meander extending across a major part of the surface of the flexible carrier 14.

Line ends 22, 24 of the electrically resistive conductor line 16 are formed to extend outwardly away from and perpendicular to the line end portions 18, 20 of the electrically resistive conductor line 16 to form a connecting region of the electric heater member 12. The line ends 22, 24 of the electrically resistive conductor line 16 and the line end portions 18, 20 in that region have an identical width w_{R}.

Furthermore, the electric heater member 12 includes two electrically conductive terminal lines 28, 30, which are attached onto the surface of the flexible carrier 14. The two electrically conductive terminal lines 28, 30 may be attached onto the surface of the flexible carrier 14 by applying a screen printing or an inkjet printing process for disposing an electrically conductive ink in the shape of the electrically conductive terminal lines 28, 30 and curing the electrically conductive ink. The electrically conductive ink comprises a major part of silver, so that the electrically conductive terminal lines 28, 30 comprise cured electrically conductive ink.

In this specific embodiment, the electrically conductive terminal lines 28, 30 have a uniform thickness t of about 10 μm, and typically have a thickness between 5 μm and 15 μm. Each one of the electrically conductive terminal lines 28, 30 abuts and is electrically connected to one of the line ends 22, 24 of the electrically resistive conductor line 16. The terminal lines 28, 30 have a uniform width w_{T} that is narrower than the uniform width w_{R} of the electrically resistive conductor line end 22, 24 in that region. For adapting the width w_{R} of the electrically resistive conductor line end 22, 24 to the width w_{T} of the terminal lines 28, 30, a tapered transition region 32 is formed in which the width w_{R} of the electrically resistive conductor line ends 22, 24 linearly decrease to the width w_{T} of the terminal lines 28, 30.

Furthermore, the electric heating device 10 includes two pairs of electrically conductive shunt members 34-40. The first pair of electrically conductive shunt members 34, 36 comprises two electrically conductive terminal shunt members. The second pair of electrically conductive shunt members 38, 40 comprises two electrically conductive conductor line shunt members.

It is noted herewith that the terms “first”, “second”, etc. are used in this application for distinction purposes only, and are not meant to indicate or anticipate a sequence or a priority in any way.

A sheet resistance of the electrically conductive shunt members 34-40 is lower than a sheet resistance of the portion of the electrically conductive terminal line 28, 30 and is lower than a sheet resistance of a bended transition portion 26 of the electrically resistive conductor line 16.

In this specific embodiment, the electrically conductive shunt members 34-40 are formed as strips of electrically conductive textile 42. The electrically conductive shunt members 34, 36 of the first pair are shaped straight. The electrically conductive shunt members 38, 40 of the second pair are bend-shaped for adaptation to the shape of the bended transition portion 26 between the line end portion 18, 20 and the line ends 22, 24 of the electrically resistive conductor line 16. Although a shape of the two pairs of electrically conductive shunt members 34-40 is different, they are identically structured. Each electrically conductive shunt member 34-40 has a band-shaped textile carrier that is completely made from polyester. A down-facing surface of each electrically conductive shunt member 34-40 is equipped with an attached continuous layer of electrically conductive material consisting of nickel. In this specific embodiment, the nickel layer has been applied to the down-facing surface by using a physical vapor deposition (PVD) process, namely by vacuum evaporation deposition. Alternatively, it may have been attached by another PVD process or galvanically by employing an electroplating process. The nickel layer extends over a major part of more than 90% of the area of the down-facing surface.

In an operational state, each electrically conductive terminal shunt member 34, 36 of the first pair of electrically conductive shunt members 34, 36 is attached to one of the electrically conductive terminal lines 28, 30 that, in turn, completely overlaps the electrically conductive shunt member 34, 36 in a direction perpendicular to the surface of the flexible carrier 14. An electrically conductive adhesive layer 44 is arranged between each electrically conductive terminal line 28, 30 and one of the first pair of electrically conductive shunt members 34, 36 for providing an appropriate attachment as an electrically conductive adhesive bond. In this way, the respective electrically conductive terminal line 28, 30 for connecting to an electric power source (not shown) is at least partially electrically shunted by the electrically conductive shunt member 34, 36.

Further, in the operational state, each electrically conductive terminal shunt member 38, 40 of the second pair of electrically conductive shunt members 38, 40 is attached to one of the bended transition portions 26 between the line end portions 18, 20 and the line ends 22, 24 of the electrically resistive conductor line 16, respectively. Each bended transition portion 26 completely overlaps the respective electrically conductive shunt member 38, 40 in a direction perpendicular to the surface of the flexible carrier 14. An electrically conductive adhesive layer 44 is arranged between each bended transition portion 26 and one of the electrically conductive shunt members 38, 40 for providing an appropriate attachment as an electrically conductive adhesive bond. In this way, the respective bended transition portion 26 between the line end portion 18, 20 and the line ends 22, 24 of the electrically resistive conductor line 16 is at least partially electrically shunted by the electrically conductive shunt member 38, 40. Without the electrically conductive shunt members 38, 40, a current density, and thus a local heat flux density, would be concentrated at an inside of the bended transition portion 26 of the electrically resistive conductor line 16, potentially generating a hot spot when the electric heating device 10 is put into operation.

In the specific embodiment pursuant to FIG. 1, the electric heating device 10 in accordance with the invention comprises only one electrically resistive conductor line 16. It will be readily acknowledged by those skilled in the art that the invention is also applicable to electric heating devices with a plurality of two or more electrically resistive conductor lines.

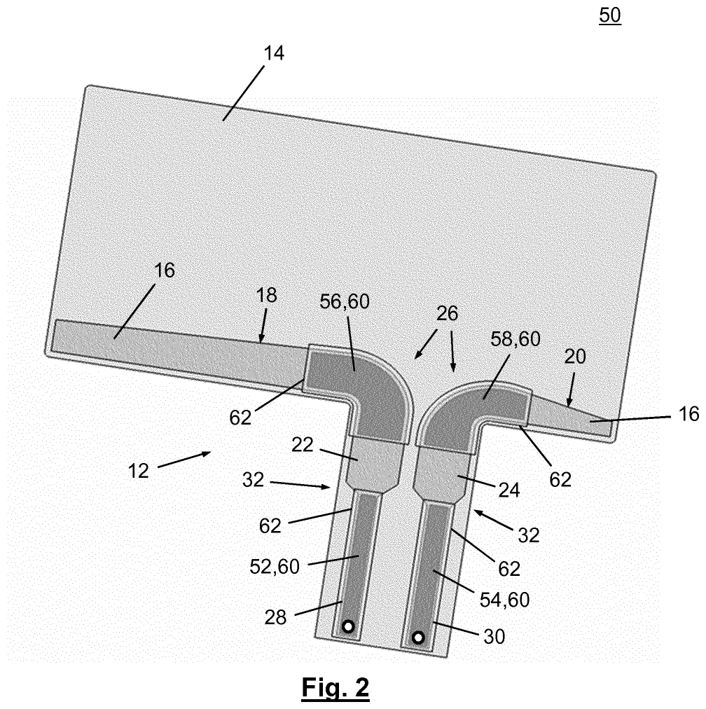

FIG. 2 schematically illustrates an alternative embodiment of an electric heating device 50 in accordance with the invention in a plan view. In order to avoid unnecessary repetitions, only differences with respect to the first embodiment pursuant to FIG. 1 will be described. For features in FIG. 2 that are not described, reference is made herewith to the description of the first embodiment.

The alternative embodiment of an electric heating device 50 also includes two pairs of electrically conductive shunt members 52-58. The first pair of electrically conductive shunt members 52, 54 comprises two electrically conductive terminal shunt members. The second pair of electrically conductive shunt members 56, 58 comprises two electrically conductive conductor line shunt members.

In this alternative embodiment, the electrically conductive shunt members 52-58 are formed as strips of copper film 60 having a uniform thickness of 15 μm. The electrically conductive shunt members 52, 54 of the first pair are shaped straight. The electrically conductive shunt members 56, 58 of the second pair are bend-shaped for adaptation to the shape of the bended transition portion 26 between the line end portion 18, 20 and the line ends 22, 24 of the electrically resistive conductor line 16.

In an operational state, a plastic film 62 with an adhesive layer comprising a pressure-sensitive adhesive is arranged on top of each one of the electrically conductive shunt members 52-58. The plastic films 62 are adhesively attached by the adhesive layer to the flexible carrier 14 at opposite sides of the electrically conductive terminal lines 28, 30 and at opposite sides of the bended transition portion 26, respectively. The plastic films 62 provide an appropriate attachment of the electrically conductive shunt members 52-58 to the electrically conductive terminal lines 28, 30 and to the bended transition portion 26 of the electrically resistive conductor line 16, respectively. The attachment can be established by temporarily applying an appropriate mechanical load to the electrically conductive shunt members 52-58.

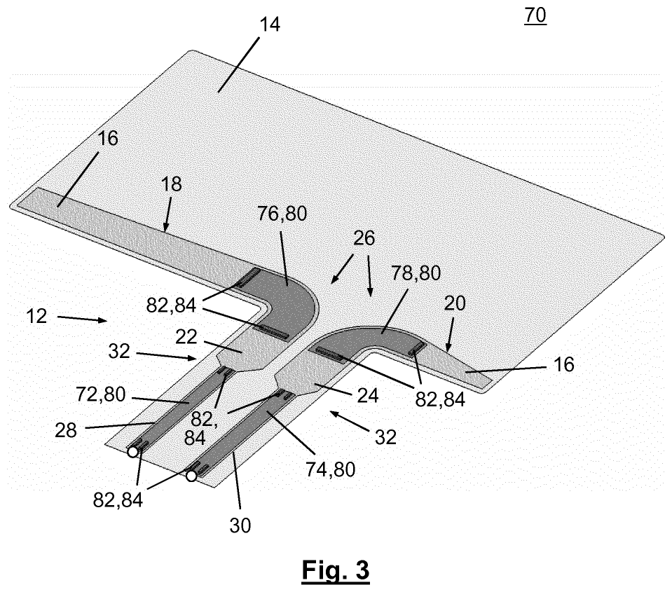

FIG. 3 schematically illustrates another alternative embodiment of an electric heating device 70 in accordance with the invention in a perspective view. In order to avoid unnecessary repetitions, again only differences with respect to the first embodiment pursuant to FIG. 1 will be described. For features in FIG. 3 that are not described, reference is made herewith to the description of the first embodiment.

The alternative embodiment of an electric heating device 70 also includes two pairs of electrically conductive shunt members 72-78. The first pair of electrically conductive shunt members 72, 74 comprises two electrically conductive terminal shunt members. The second pair of electrically conductive shunt members 76, 78 comprises two electrically conductive conductor line shunt members.

In this alternative embodiment, the electrically conductive shunt members 72-78 are formed as strips of plastic foil 80 made from polyester with an attached electrically conductive layer comprising cured electrically highly conductive ink and having a uniform thickness of 10 μm. The electrically conductive shunt members 72, 74 of the first pair are shaped straight. The electrically conductive shunt members 76, 78 of the second pair are bend-shaped for adaptation to the shape of the bended transition portion 26 between the line end portion 18, 20 and the line ends 22, 24 of the electrically resistive conductor line 16.

In an operational state, each electrically conductive terminal shunt member 72, 74 of the first pair of electrically conductive shunt members is attached to one of the electrically conductive terminal lines 28, 30 with the electrically conductive layer facing the respective electrically conductive terminal line 28, 30.

Further, in the operational state, each electrically conductive shunt member 76, 78 of the second pair of electrically conductive shunt members is attached to one of the bended transition portions 26, respectively, with the electrically conductive layer facing the respective bended transition portion 26.

An appropriate attachment of the electrically conductive shunt members 72-78 to the terminal lines 28, 30 or to the bended transition portion 26 of the electrically resistive conductor line 16, respectively, is achieved by means for establishing form fit joints.

In this specific embodiment, the form fit joints are established by rivets 82 that are positioned at ends of each of the electrically conductive shunt members 72-78. The rivets 82 may be formed as metallic rivets or as rivets made from plastic material. In other embodiments, a combined force/form fit joint may be established for the attachment by applying a clinching method at ends of each of the electrically conductive shunt members 72-78, as is well known in the art.

In other alternative embodiments of the electric heating device, an appropriate attachment of the electrically conductive shunt members 72-78 to the terminal lines 28, 30 or to the bended transition portion 26 of the electrically resistive conductor line 16, respectively, may be achieved by means for establishing material bond joints 84 that are positioned at ends of each of the electrically conductive shunt members 72-78. The material bond joints 84 may be established by soldering.

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, which is meant to express a quantity of at least two. The mere fact that certain measures are recited in mutually different dependent claims does not indicate that a combination of these measures cannot be used to advantage. Any reference signs in the claims should not be construed as limiting scope.

1. An electric heating device, in particular for automotive application, comprising:
at least one electric heater member that includes:
a dielectric, planar, flexible carrier,
at least one electrically resistive conductor line of uniform thickness (t) that is fixedly attached onto a surface of the flexible carrier,
at least for one end of the at least one electrically resistive conductor line an electrically conductive terminal line, being attached onto the surface of the flexible carrier, and abutting and being electrically connected to the respective end of the at least one electrically resistive conductor line, wherein the electrically conductive terminal lines have a width that is narrower than a width of the at least one electrically resistive conductor line, and
at least one electrically conductive shunt member, being attached to at least one out of at least a portion of at least one of the electrically conductive terminal lines and a portion of the at least one electrically resistive conductor line for at least partially electrically shunting the respective portion.

2. The electric heating device claimed in claim 1, including an electrically conductive adhesive layer that is arranged between the portion of the terminal line or the portion of the at least one electrically resistive conductor line and the at least one electrically conductive shunt member for providing an appropriate attachment as an electrically conductive adhesive bond.

3. The electric heating device as claimed in claim 1, including a plastic film and an adhesive layer that are arranged on top of the at least one electrically conductive shunt member, and wherein the plastic film is adhesively attached by the adhesive layer to the flexible carrier at opposite sides of the portion of the terminal line or at opposite sides of the portion of the at least one electrically resistive conductor line for providing an appropriate attachment for the at least one electrically conductive shunt member.

4. The electric heating device as claimed in claim 1, wherein the at least one electrically conductive shunt member is attached to at least the portion of the terminal line or the portion of the at least one electrically resistive conductor line by means for establishing at least one material bond joint.

5. The electric heating device as claimed in claim 1, wherein the at least one electrically conductive shunt member is attached to at least the portion of the terminal line or to the portion of the at least one electrically resistive conductor line by means for establishing at least one force/form fit joint, form fit joint or combined force/form fit joint.

6. The electric heating device as claimed in claim 1, wherein the at least one electrically conductive shunt member is formed as at least one out of a strip of an electrically conductive textile, a strip of copper film and a strip of plastic foil with an attached electrically conductive layer comprising cured electrically highly conductive ink.

7. The electric heating device as claimed in claim 1, wherein the at least one electrically conductive shunt member is formed as a strip of an electrically conductive textile having a textile carrier and a continuous electrically conductive layer attached to a surface of the textile carrier and extending over a major part of an area of the surface, wherein the continuous electrically conductive layer comprises at least one material out of a group formed by copper, nickel, silver, manganese and a combination of at least two of these.

8. The electric heating device as claimed in claim 1, wherein the portion of the terminal line or the portion of the at least one electrically resistive conductor line completely overlaps the at least one electrically conductive shunt member in a direction perpendicular to the surface of the flexible carrier.

9. The electric heating device as claimed in claim 1, wherein a sheet resistance of the at least one electrically conductive shunt member is lower than a sheet resistance of the portion of the electrically conductive terminal line or of the portion of the at least one electrically resistive conductor line.

10. The electric heating device as claimed in claim 1, wherein the flexible carrier is a foil that is substantially made from a plastic material selected from a group of plastic materials formed by polyethylene terephthalate, polyimide, polyetherimide, polyethylene naphthalate, polyoxymethylene, polamide, polyphthalamide, polyether ether ketone, and combinations of at least two of these plastic materials.

11. The electric heating device as claimed in claim 1 wherein the at least one electrically resistive conductor line comprises a cured electrically resistive ink.
